(19) United States
(12) Patent Application Publication
(10) Pub. No.: US 2025/0349469 A1
(43) Pub. Date: Nov. 13, 2025

(54) ELECTRONIC COMPONENT

(71) Applicant: TDK Corporation, Tokyo (JP)

(72) Inventors: Kosuke NAKANOME, Tokyo (JP); Shinya ONODERA, Tokyo (JP)

(73) Assignee: TDK Corporation, Tokyo (JP)

(21) Appl. No.: 19/078,521

(22) Filed: Mar. 13, 2025

(30) Foreign Application Priority Data
May 8, 2024 (JP) 2024-075792

(51) Int. Cl. H01G 4/232; H01G 4/008

(52) U.S. Cl. CPC H01G 4/2325; H01G 4/008

(57) ABSTRACT

An electronic component includes an element body and an external electrode. The external electrode is disposed on the element body, and includes a conductive resin layer. The conductive resin layer includes a plurality of conductive particles. The plurality of conductive particles include a metal component including silver. An oxide is positioned on an end side of the conductive resin layer.

### CROSS-REFERENCE TO RELATED APPLICATIONS

This application is based upon and claims the benefit of priority from Japanese Patent Application No. 2024-075792, filed on May 8, 2024, the entire contents of which are incorporated herein by reference.

### BACKGROUND

### Field

The present disclosure relates to an electronic component.

### Description of the Related Art

Known electronic components include an element body and an external electrode including a conductive resin layer and disposed on the element body (see, for example, Japanese Unexamined Patent Publication No. H5-144665).

### SUMMARY

The conductive resin layer includes, for example, a plurality of conductive particles and a resin. The conductive particles include, for example, silver (Ag). The silver has high electrical conductivity and tends not to be oxidized. In a configuration in which the conductive particles include the silver, silver migration may occur in the external electrode. The silver migration is considered to occur due to the following events, for example.

Electric field or heat acts on the conductive resin layer, and the silver is ionized. The silver included in the conductive resin layer may be ionized under influence of oxygen. Generated silver ion is attracted by electric field between the external electrodes and migrates from the conductive resin layer. The electric field acting on the silver includes, for example, electric field between the external electrodes or electric field between the external electrode and an internal conductor in the element body. The silver ion migrating from the conductive resin layer react with, for example, an electron supplied from the internal conductor or the external electrode, and is deposited as silver on a surface of the element body.

One aspect of the present disclosure provides an electronic component preventing progress of silver migration.

An electronic component according to one aspect of the present disclosure includes an element body and an external electrode disposed on the element body. The external electrode includes a conductive resin layer including a plurality of conductive particles. The plurality of conductive particles include a metal component including silver. An oxide is positioned on an end side of the conductive resin layer.

In the one aspect described above, the oxide is positioned on the end side of the conductive resin layer. The oxide tends not to cause migration more than silver. Therefore, even in an environment in which silver migration may occur, the silver migration tends not to progress from the conductive resin layer. The one aspect described above prevents progress of silver migration.

The one aspect described above may include the following configuration. In this configuration, for example, the conductive resin layer includes an edge including the oxide.

In a configuration in which the conductive resin layer includes the edge including the oxide, the conductive resin layer includes the oxide at an edge of the conductive resin layer. Therefore, this configuration reliably prevents the progress of silver migration.

The one aspect described above may include the following configurations. In this configuration, for example, the edge includes a surface where the oxide is exposed.

A configuration in which the edge includes the surface where the oxide is exposed further reliably prevents the progress of silver migration.

The one aspect described above may include the following configurations. In this configuration, for example, the external electrode includes a plating layer disposed outside the conductive resin layer with a gap between the plating layer and the element body, and the oxide is exposed to the gap.

In a configuration in which the external electrode includes the plating layer, the plating layer has the gap between the plating layer and the element body. For example, oxygen tends to enter through the gap between the plating layer and the element body when heat-treating the conductive resin layer. Therefore, even in a configuration in which the external electrode includes the plating layer, the oxide can be reliably disposed.

In a configuration in which the oxide is exposed to the gap, the oxide prevents silver ion from migrating from the conductive resin layer to the gap. Therefore, even in a configuration in which the plating layer has the gap between the plating layer and the element body, a configuration in which the oxide is exposed to the gap reliably prevents the progress of silver migration.

The one aspect described above may include the following configurations. In this configuration, for example, the conductive resin layer includes an edge on which the oxide is disposed.

In a configuration in which the conductive resin layer includes an edge on which the oxide is disposed, the oxide is positioned in front of the edge of the conductive resin layer. Therefore, this configuration reliably prevents the progress of silver migration.

The one aspect described above may include the following configurations. In this configuration, for example, the external electrode includes a plating layer disposed outside the conductive resin layer with a gap between the plating layer and the element body, and the oxide is positioned in the gap.

In a configuration in which the external electrode includes the plating layer, the oxide can be easily and reliably disposed as described above.

In a configuration in which the oxide is positioned in the gap, the oxide prevents silver ion from migrating through the gap. Therefore, even in a configuration in which the plating layer has the gap between the plating layer and the element body, a configuration in which the oxide is positioned in the gap reliably prevents the progress of silver migration.

The one aspect described above may include the following configurations. In this configuration, for example, the oxide includes an oxide of the metal component included in the conductive particle.

In a configuration in which the oxide includes the oxide of the metal component included in the conductive particle, the oxide included in an edge of the conductive resin layer includes the oxide of the metal component included in the conductive particle. Therefore, this configuration reliably and easily provides the oxide positioned on the end side of the conductive resin layer.

The one aspect described above may include the following configurations. In this configuration, for example, the conductive particle includes copper, and the oxide includes an oxide of the silver and the copper.

In a configuration in which the oxide includes an oxide including the silver and the copper, for example, the oxide may be formed through heat-treating the conductive resin layer. Therefore, this configuration can more easily provide the oxide positioned on the end side of the conductive resin layer.

The one aspect described above may include the following configurations. In this configuration, for example, the conductive particle includes a core including the copper, and a film including the silver and covering the core.

A configuration in which the conductive particle includes the core including the copper and the film including the silver reduces electrical resistance of the conductive particle as compared with a configuration in which the conductive particle includes only copper. Therefore, this configuration in which the conductive particle includes the core including the copper and the film including the silver reduces the electrical resistance of the conductive resin layer and reduces ESR (equivalent series resistance) of the electronic component. This configuration can reliably and easily form the oxide including the silver and the copper.

The one aspect described above may include the following configurations. In this configuration, for example, the oxide is positioned on a surface of the film.

A configuration in which the oxide is positioned on the surface of the film can further reliably provide the oxide positioned on the end side of the conductive resin layer.

The one aspect described above may include the following configurations. In this configuration, for example, the oxide extends along an edge of the external electrode.

A configuration in which the oxide extends along the edge of the external electrode reliably prevents the progress of silver migration.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor according to the example;

FIG. 3 is a view illustrating a cross-sectional configuration of the multilayer capacitor according to the example;

FIG. 4 is a view illustrating a cross-sectional configuration of an external electrode;

FIG. 5 is a view illustrating a configuration of a conductive particle;

FIG. 6 is a plan view illustrating a second electrode layer;

FIG. 7 is a view illustrating a configuration of the external electrode and an oxide;

FIGS. 8A and 8B are views illustrating a configuration of the conductive particle;

FIG. 9 is a view illustrating a configuration of an external electrode and an oxide; and

FIG. 10 is a plan view illustrating a second electrode layer.

### DETAILED DESCRIPTION

In the following description, with reference to the drawings, the same reference numbers are assigned to the same components or to similar components having the same function, and overlapping description is omitted.

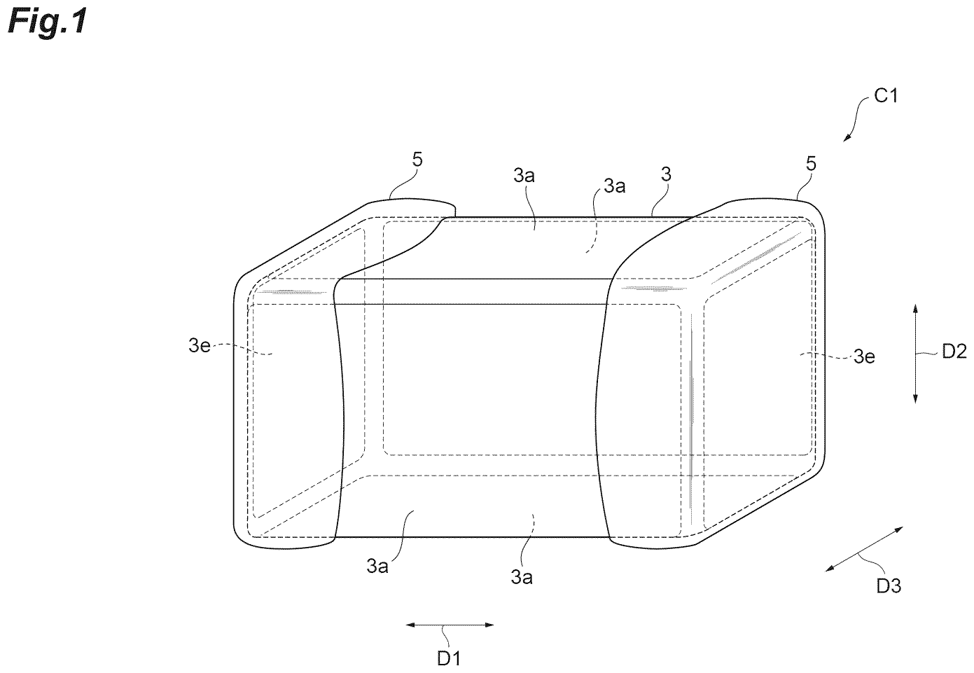

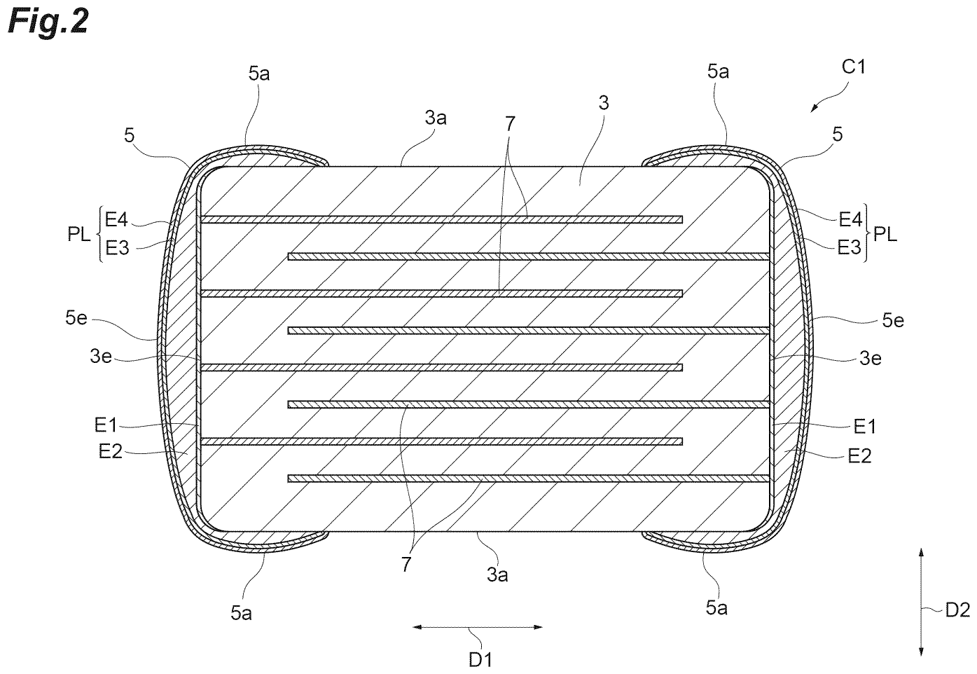

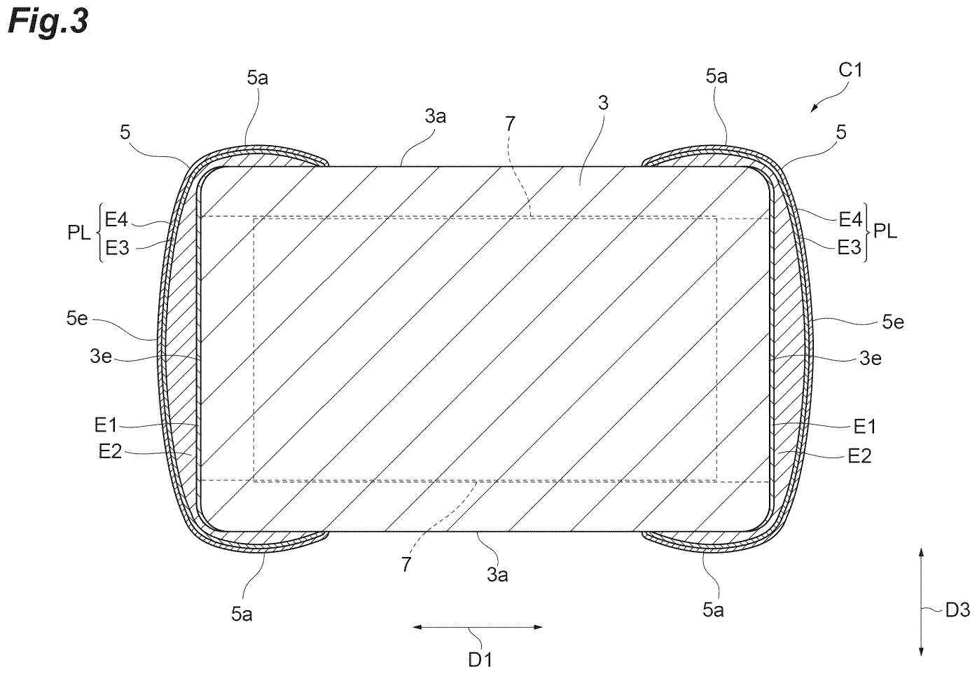

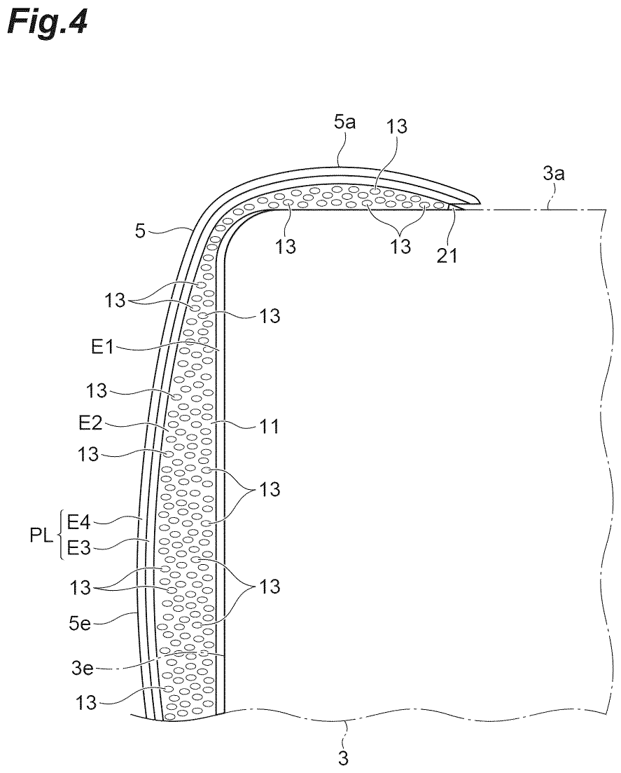

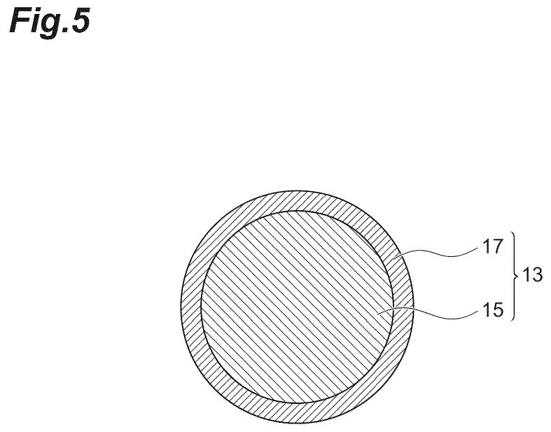

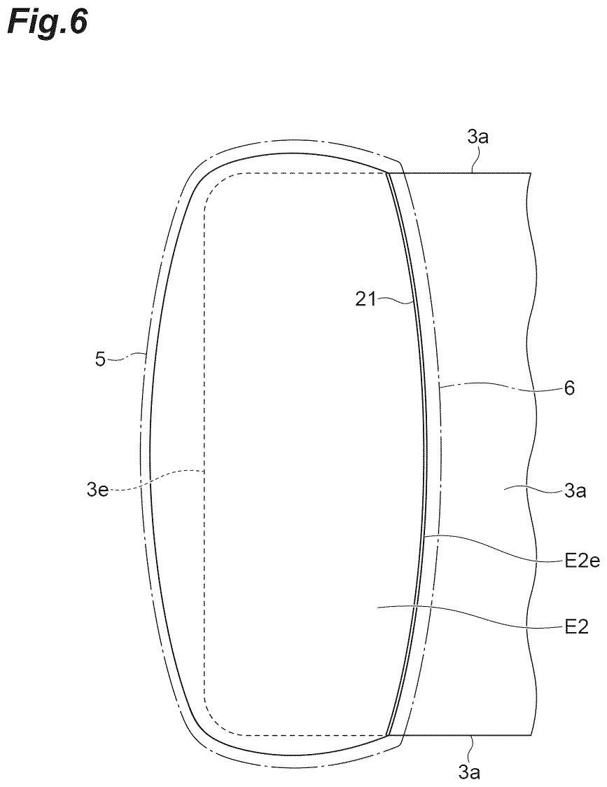

A configuration of a multilayer capacitor C1 according to the example will be described with reference to FIGS. 1 to 6. FIG. 1 is a perspective view of a multilayer capacitor according to the example. FIGS. 2 and 3 are views illustrating a cross-sectional configuration of the multilayer capacitor according to the example. FIG. 4 is a view illustrating a cross-sectional configuration of an external electrode. FIG. 5 is a view illustrating a configuration of a conductive particle. FIG. 6 is a plan view illustrating a second electrode layer.

An electronic component includes, for example, the multilayer capacitor C1.

As illustrated in FIG. 1, the multilayer capacitor C1 includes an element body 3 of a rectangular parallelepiped shape and a plurality of external electrodes 5. For example, the multilayer capacitor C1 includes a pair of external electrodes 5. The pair of external electrodes 5 are disposed on an outer surface of the element body 3. The pair of external electrodes 5 are separated from each other. The rectangular parallelepiped shape includes a rectangular parallelepiped shape in which corners and ridges are chamfered, or a rectangular parallelepiped shape in which the corners and ridges are rounded.

The element body 3 includes four side surfaces 3a and a pair of end surfaces 3e opposing each other. The four side surfaces 3a and the pair of end surfaces 3e each have a substantially rectangular shape. The four side surfaces 3a include a first pair of side surfaces 3a opposing each other and a second pair of side surfaces 3a opposing each other. A direction in which the first pair of side surfaces 3a oppose each other includes a direction D2. A direction in which the second pair of side surfaces 3a oppose each other includes a direction D3. A direction in which the pair of end surfaces 3e oppose each other includes a direction D1.

The multilayer capacitor C1 is solder-mounted on an electronic device, for example. The electronic device includes, for example, a circuit board or an electronic component. In the multilayer capacitor C1, for example, one of the four side surfaces 3a opposes the electronic device. The one of the four side surfaces 3a is arranged to constitute a mounting surface. The one of the four side surfaces 3a includes the mounting surface.

The direction D2 includes a direction perpendicular to the first pair of side surfaces 3a, and is perpendicular to the direction D3. The direction D1 includes a direction parallel to the four side surfaces 3a, and is perpendicular to the direction D2 and the direction D3. The direction D3 includes a direction perpendicular to the second pair of side surfaces 3a, and the direction D1 includes a direction perpendicular to the end surfaces 3e. For example, a length of the element body 3 in the direction D1 is larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

The length of the element body 3 in the direction D2 defines, for example, a height of the element body 3. The length of the element body 3 in the direction D3 defines, for example, a width of the element body 3. The length of the element body 3 in the direction D1 defines, for example, a longitudinal length of the element body 3. For example, the height of the element body 3 is 0.1 to 3.2 mm, the width of the element body 3 is 0.1 to 6.3 mm, and the longitudinal length of the element body 3 is 0.2 to 7.5 mm. For example, the height of the element body 3 is 2.5 mm, the width of the element body 3 is 2.5 mm, and the longitudinal length of the element body 3 is 3.2 mm.

The first pair of side surfaces 3a extend in the direction D3 to couple the second pair of side surfaces 3a to each other. The first pair of side surfaces 3a also extend in the direction D1. The second pair of side surfaces 3a extend in the direction D2 to couple the first pair of side surfaces 3a to each other. The second pair of side surfaces 3a also extend in the direction D1. The pair of end surfaces 3e extend in the direction D2 to couple the first pair of side surfaces 3a to each other. The pair of end surfaces 3e also extend in the direction D3 to couple the second pair of side surfaces 3a to each other.

The element body 3 includes a ridge portion between the end surface 3e and the side surface 3a and a ridge portion between one of the first pair of side surfaces 3a and one of the second pair of side surfaces 3a. For example, the ridge portions are rounded to be curved. For example, the element body 3 is subjected to what is called a round chamfering process. The end surface 3e and the side surface 3a are indirectly adjacent to each other with the ridge portion between the end surface 3e and the side surface 3a. The one of the first pair of side surfaces 3a and the one of the second pair of side surfaces 3a are indirectly adjacent to each other with the ridge portion between the one of the first pair of side surfaces 3a and the one of the second pair of side surfaces 3a.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. Each dielectric layer includes, for example, a sintered body of a ceramic green sheet containing a dielectric material. Examples of the dielectric material include dielectric ceramics. Examples of the dielectric ceramics include BaTiO₃-based, Ba (Ti, Zr) O₃-based, or (Ba, Ca) TiO₃-based dielectric ceramics. In the actual element body 3, each of the dielectric layers is integrated to such an extent that a boundary between the dielectric layers cannot be visually recognized.

As illustrated in FIGS. 2 and 3, the multilayer capacitor C1 includes a plurality of internal electrodes 7. Each of the internal electrodes 7 includes an internal conductor disposed in the element body 3. Each of the internal electrodes 7 is made of an electrically conductive material that is commonly used as an internal conductor of a multilayer electronic component. The electrically conductive material includes, for example, a base metal. The electrically conductive material includes, for example, nickel (Ni) or copper (Cu). Each of the internal electrodes 7 is configured as a sintered body of electrically conductive paste containing the electrically conductive material described above. For example, the internal electrodes 7 include nickel.

The plurality of internal electrodes 7 are disposed in different positions (layers) in the direction D2. The plurality of internal electrodes 7 are disposed in the element body 3 to oppose each other in the direction D2 with an interval therebetween. The internal electrodes 7 adjacent to each other in the direction D2 have different polarities from each other. One end of the internal electrode 7 is exposed to a corresponding end surface 3e of the pair of end surfaces 3e. The internal electrode 7 includes one end exposed to the corresponding end surface 3e. The plurality of internal electrodes 7 include an internal electrode 7 exposed to one end surface 3e of the pair of end surfaces 3e and an internal electrode 7 exposed to the other end surface 3e of the pair of end surfaces 3e. The internal electrodes 7 exposed to the one end surface 3e and the internal electrodes 7 exposed to the other end surface 3e are alternately disposed in the direction D2.

The plurality of internal electrodes 7 are disposed in the element body 3 to be distributed in the direction D2. Each of the plurality of internal electrodes 7 is positioned in a plane substantially parallel to the first pair of side surfaces 3a. A direction in which the internal electrodes 7 oppose each other, that is, the direction D2 is perpendicular to a direction parallel to the first pair of side surfaces 3a. The direction in which the internal electrodes 7 oppose each other is perpendicular to the directions D3 and D1.

In a configuration in which the lamination direction of the plurality of dielectric layers includes the direction D3, the plurality of internal electrodes 7 are disposed in different positions (layers) in the direction D3. In a configuration in which the lamination direction of the plurality of dielectric layers includes the direction D3, the internal electrodes 7 exposed to the one end surface 3e and the internal electrodes 7 exposed to the other end surface 3e are alternately disposed in the direction D3. Each of the plurality of internal electrodes 7 is positioned in a plane substantially parallel to the second pair of side surfaces 3a. The internal electrodes 7 oppose each other in the direction D3.

As illustrated in FIG. 1, the external electrodes 5 are disposed at both ends of the element body 3 in the first direction D1. Each external electrode 5 is disposed on a corresponding end surface 3e of the pair of end surfaces 3e. For example, each external electrode 5 is disposed on the four side surfaces 3a and the one end surface 3e. The external electrode 5 includes a plurality of electrode portions 5a and 5e, as illustrated in FIGS. 2 and 3. The electrode portion 5a is disposed on both the side surface 3a and the ridge portion between the side surface 3a and the end surface 3e. The electrode portion 5e is disposed on the end surface 3e. The external electrode 5 also includes an electrode portion disposed on the ridge portion between the adjacent side surfaces 3a. Hereinafter, the ridge portion between the side surface 3a and the end surface 3e is referred to as a first ridge portion, and the ridge portion between the adjacent side surfaces 3a is referred to as a second ridge portion.

Each external electrode 5 is formed on five surfaces of the four side surfaces 3a and the end surface 3e as well as the above-described ridge portions. The electrode portions 5a and 5e adjacent to each other are coupled and are electrically connected to each other. The electrode portion 5e covers the entire one end of a corresponding internal electrode 7 of the plurality of internal electrodes 7. The electrode portion 5e is directly connected to the corresponding internal electrode 7. The external electrode 5 is electrically connected to the corresponding internal electrode 7.

As illustrated in FIGS. 2 to 4, the external electrode 5 includes a first electrode layer E1, a second electrode layer E2, a third electrode layer E3, and a fourth electrode layer E4. The fourth electrode layer E4 includes the outermost layer of the external electrode 5. Each of the electrode portions 5a and 5e includes the first electrode layer E1, the second electrode layer E2, the third electrode layer E3, and the fourth electrode layer E4.

The first electrode layer E1 of the electrode portion 5a is disposed on the first ridge portion and not disposed on the side surface 3a. The first electrode layer E1 of the electrode portion 5a covers the entire first ridge portion. The first electrode layer E1 of the electrode portion 5a does not cover the side surface 3a. The first electrode layer E1 of the electrode portion 5a is in contact with the first ridge portion. The side surface 3a is exposed from the first electrode layer E1. The first electrode layer E1 of the electrode portion 5a may be disposed on the side surface 3a. The first electrode layer E1 of the electrode portion 5a may cover a partial region of the side surface 3a and the entire first ridge portion. The first electrode layer E1 of the electrode portion 5a may be in contact with the partial region of the side surface 3a. The partial region covered with the first electrode layer E1 of the electrode portion 5a may be positioned closer to the end surface 3e.

The second electrode layer E2 of the electrode portion 5a is disposed on both the first electrode layer E1 and the side surface 3a. In the electrode portion 5a, the second electrode layer E2 covers the entire first electrode layer E1 and a partial region of the side surface 3a. The second electrode layer E2 of the electrode portion 5a indirectly covers the first ridge portion such that the first electrode layer E1 is positioned between the second electrode layer E2 and the element body 3. In the electrode portion 5a, the second electrode layer E2 is in direct contact with the first electrode layer E1. The partial region covered with the second electrode layer E2 of the electrode portion 5a is positioned closer to the end surface 3e. The side surface 3a is exposed from the second electrode layer E2 at the remaining region excluding the partial region covered with the second electrode layer E2. In the electrode portion 5a, the second electrode layer E2 is in direct contact with the side surface 3a. In the electrode portion 5a, the second electrode layer E2 directly covers the side surface 3a. The second electrode layer E2 of the electrode portion 5a is positioned on both the side surface 3a and the first ridge portion.

The third electrode layer E3 of the electrode portion 5a is disposed on the second electrode layer E2. In the electrode portion 5a, the third electrode layer E3 covers the second electrode layer E2. In the electrode portion 5a, the third electrode layer E3 is in contact with the second electrode layer E2. In the electrode portion 5a, the third electrode layer E3 is in direct contact with the second electrode layer E2.

The fourth electrode layer E4 of the electrode portion 5a is disposed on the third electrode layer E3. In the electrode portion 5a, the fourth electrode layer E4 covers the third electrode layer E3. In the electrode portion 5a, the fourth electrode layer E4 is in contact with the third electrode layer E3. In the electrode portion 5a, the fourth electrode layer E4 is in direct contact with the third electrode layer E3.

In the electrode portion 5a, the third electrode layer E3 and the fourth electrode layer E4 are not in contact with the side surface 3a. In the electrode portion 5a, the third electrode layer E3 is disposed outside the second electrode layer E2 with a gap G_{E3} between the third electrode layer E3 and the side surface 3a. In the electrode portion 5a, the fourth electrode layer E4 is disposed outside the second electrode layer E2 with a gap G_{E4} between the fourth electrode layer E4 and the side surface 3a. The fourth electrode layer E4 of the electrode portion 5a is disposed outside the third electrode layer E3 of the electrode portion 5a. The third electrode layer E3 and fourth electrode layer E4 of the electrode portion 5a are positioned on the side surface 3a.

For example, in a configuration in which the one side surface 3a of the first pair of side surfaces 3a is arranged to constitute the mounting surface, the second electrode layer E2 of the electrode portion 5a positioned on each of the second pair of side surfaces 3a may cover only a partial region of the ridge portion between the end surface 3e and each of the second pair of side surfaces 3a, and only a partial region of each of the second pair of side surfaces 3a. The partial region of the ridge portion between the end surface 3e and each of the second pair of side surfaces 3a is positioned, for example, closer to the side surface 3a arranged to constitute the mounting surface. The partial region of each of the second pair of side surfaces 3a is positioned, for example, closer to a corner closer to the side surface 3a arranged to constitute the mounting surface and the end surface 3e.

The electrode portion 5a positioned on each of the second pair of side surfaces 3a may have the following configuration. The second electrode layer E2 of the electrode portion 5a positioned on each of the second pair of side surfaces 3a indirectly covers the partial region of the ridge portion between the end surface 3e and each of the second pair of side surfaces 3a such that the first electrode layer E1 is positioned between the second electrode layer E2 and the first ridge portion. The second electrode layer E2 of the electrode portion 5a positioned on each of the second pair of side surfaces 3a directly covers the partial region of each of the second pair of side surfaces 3a. The second electrode layer E2 of the electrode portion 5a positioned on each of the second pair of side surfaces 3a directly covers a partial region of a portion, of the first electrode layer E1, positioned on the ridge portion between the end surface 3e and each of the second pair of side surfaces 3a. The electrode portion 5a positioned on each of the second pair of side surfaces 3a includes a region in which the first electrode layer E1 is exposed from the second electrode layer E2 and a region in which the first electrode layer E1 is covered with the second electrode layer E2.

The first electrode layer E1 of the electrode portion 5e is disposed on the end surface 3e. The first electrode layer E1 of the electrode portion 5e covers the entire end surface 3e. The first electrode layer E1 of the electrode portion 5e is in contact with the entire end surface 3e. In the electrode portion 5e, the first electrode layer E1 is in direct contact with the end surface 3e.

The second electrode layer E2 of the electrode portion 5e is disposed on the first electrode layer E1. In the electrode portion 5e, the second electrode layer E2 covers the first electrode layer E1. In the electrode portion 5e, the second electrode layer E2 is in direct contact with the first electrode layer E1. In the electrode portion 5e, the second electrode layer E2 indirectly covers the end surface 3e such that the first electrode layer E1 is positioned between the second electrode layer E2 and the end surface 3e. The second electrode layer E2 of the electrode portion 5e is positioned on the end surface 3e.

The third electrode layer E3 of the electrode portion 5e is disposed on the second electrode layer E2. In the electrode portion 5e, the third electrode layer E3 covers the second electrode layer E2. In the electrode portion 5e, the third electrode layer E3 is in contact with the second electrode layer E2. In the electrode portion 5e, the third electrode layer E3 is in direct contact with the second electrode layer E2. In the electrode portion 5e, the third electrode layer E3 is not in direct contact with the first electrode layer E1.

The fourth electrode layer E4 of the electrode portion 5e is disposed on the third electrode layer E3. In the electrode portion 5e, the fourth electrode layer E4 covers the third electrode layer E3. In the electrode portion 5e, the fourth electrode layer E4 is in contact with the third electrode layer E3. In the electrode portion 5e, the fourth electrode layer E4 is in direct contact with the third electrode layer E3.

In the electrode portion 5e, the third electrode layer E3 and the fourth electrode layer E4 are disposed outside the second electrode layer E2. The fourth electrode layer E4 of the electrode portion 5e is disposed outside the third electrode layer E3 of the electrode portion 5e. The third electrode layer E3 and fourth electrode layer E4 of the electrode portion 5e are positioned on the end surface 3e.

The second electrode layer E2 of the electrode portion 5e may cover only a partial region of the end surface 3e. The partial region of the end surface 3e is positioned closer to the side surface 3a, for example. The electrode portion 5c may have the following configuration. The second electrode layer E2 of the electrode portion 5e indirectly covers the partial region of the end surface 3e such that the first electrode layer E1 is positioned between the second electrode layer E2 and the end surface 3e. The second electrode layer E2 of the electrode portion 5e directly covers only a partial region of a portion, of the first electrode layer E1, positioned on the end surface 3e. The electrode portion 5e includes a region in which the first electrode layer E1 is exposed from the second electrode layer E2 and a region in which the first electrode layer E1 is covered with the second electrode layer E2.

The first electrode layer E1 is formed from sintering electrically conductive paste applied onto the surface of the element body 3. The electrically conductive paste is applied onto the end surface 3e and the first ridge portions. The first electrode layer E1 is formed to cover the end surface 3e and the first ridge portions. The first electrode layer E1 is formed from sintering a metal component (metal particles) included in the electrically conductive paste. The first electrode layer E1 includes a sintered metal layer. The first electrode layer E1 includes the sintered metal layer formed on the element body 3. For example, the first electrode layer E1 includes a sintered metal layer made of copper. The first electrode layer E1 may include a sintered metal layer made of nickel. The first electrode layer E1 may include a base metal. The electrically conductive paste includes, for example, particles made of copper or nickel, a glass component, an organic binder, and an organic solvent. The first electrode layers E1 included in the electrode portions 5a and 5e are formed integrally with each other.

The second electrode layer E2 is formed from curing electrically conductive resin paste applied onto the first electrode layer E1. The electrically conductive resin paste is applied onto the first electrode layer E1 and the partial regions of the side surfaces 3a. The second electrode layer E2 is formed on both the first electrode layer E1 and the element body 3. The electrically conductive resin paste includes, for example, a plurality of conductive particles, a resin, and an organic solvent. The resin includes, for example, a thermosetting resin. The thermosetting resin is, for example, a phenol resin, an acrylic resin, a silicone resin, an epoxy resin, or a polyimide resin. The second electrode layer E2 is in contact with a part of the second ridge portion. The second electrode layers E2 included in the electrode portions 5a and 5e are integrally formed with each other.

The second electrode layer E2 includes a conductive resin layer covering the first electrode layer E1. As illustrated in FIG. 4, the second electrode layer E2 includes a resin 11 and a plurality of conductive particles 13. The plurality of conductive particles 13 form electrically conductive paths in the second electrode layer E2. FIG. 4 schematically illustrates a cross-sectional configuration of the external electrode 5. In FIG. 4, hatching indicating a cross section is omitted. The shape and size of the conductive particles 13 illustrated in FIGS. 4 and 5 may be different from the shape and size of actual conductive particles.

The conductive particle 13 includes a metal component. This metal component includes silver. For example, as illustrated in FIG. 5, the conductive particle 13 includes a core 15 and a film 17 covering the core 15. The core 15 is made of copper. The core 15 includes the copper. The film 17 is made of silver. The film 17 includes the silver. The film 17 is in contact with the core 15, for example. The film 17 directly covers the core 15, for example. A thickness of the film 17 is, for example, 100 to 700 nm. The film 17 includes the outermost layer of conductive particle 13. The conductive particle 13 includes a surface where the film 17 is exposed. The surface of the conductive particle 13 is exposed where the film 17 is present. The conductive particles 13 adjacent to each other are electrically connected to each other by the films 17 being in contact with or close to each other. The conductive particle 13 has electrical conductivity. The conductive particle 13 has a spherical shape, for example. The conductive particle 13 may have a flake shape. The plurality of conductive particles 13 may include a spherical conductive particle 13 and a flake-shaped conductive particle 13.

For example, the conductive particles 13 included in the second electrode layer E2 are contained in an amount of 30 vol % or more relative to the entire volume of the second electrode layer E2. In a configuration in which the content ratio of the conductive particles 13 to the entire volume of the second electrode layer E2 is 30 vol % or more, the conductive particles 13 tend to be distributed to an edge E2e of the second electrode layer E2 or to the vicinity of the edge E2e.

For example, the conductive particles 13 contained in the second electrode layer E2 are contained in an amount of 70 vol % or less relative to the entire volume of the second electrode layer E2. In a configuration in which the content ratio of the conductive particles 13 to the total volume of the second electrode layer E2 is 70 vol % or less, the second electrode layer E2 tends to reliably maintain a stress relaxation function of the second electrode layer E2.

The third electrode layer E3 is formed on the second electrode layer E2 through a plating process. The third electrode layer E3 includes, for example, a metal plating layer. The third electrode layer E3 may include a nickel plating layer. The third electrode layer E3 may include nickel. The nickel plating layer tends to have better solder leach resistance than the conductive particle 13 included in the second electrode layer E2. The third electrode layer E3 covers the second electrode layer E2.

The fourth electrode layer E4 is formed on the third electrode layer E3 through a plating process. The fourth electrode layer E4 includes, for example, a metal plating layer. The fourth electrode layer E4 may include a solder plating layer. The solder plating layer may include a tin (Sn) plating layer. The fourth electrode layer E4 may include tin. The fourth electrode layer E4 may include a tin-silver alloy (Sn—Ag) plating layer, a tin-bismuth alloy (Sn—Bi) plating layer, or a tin-copper alloy (Sn—Cu) plating layer. The fourth electrode layer E4 covers the third electrode layer E3.

The third electrode layer E3 and the fourth electrode layer E4 are included in a plating layer PL formed on the second electrode layer E2. That is, the external electrode 5 includes the plating layer PL, and the plating layer PL includes the third electrode layer E3 and the fourth electrode layer E4. The plating layer PL covers the second electrode layer E2. The third electrode layers E3 included in the electrode portions 5a and 5e are formed integrally with each other. The fourth electrode layers E4 included in the electrode portions 5a and 5e are formed integrally with each other. The plating layer PL may include an other plating layer between the second electrode layer E2 and the third electrode layer E3. The plating layer PL may include an other plating layer between the third electrode layer E3 and the fourth electrode layer E4.

The plating layer PL covering the second electrode layer E2 tends to be in close contact with the second electrode layer E2, but tends not to be in close contact with the element body 3. Therefore, the plating layer PL is separated from the element body 3 and has a gap between the plating layer PL and the element body 3. The third electrode layer E3 has the gap G_{E3} between the side surface 3a and the third electrode layer E3. The gap G_{E3} is present between an end of the third electrode layer E3 and the side surface 3a. The fourth electrode layer E4 has the gap G_{E4} between the side surface 3a and the fourth electrode layer E4. The gap G_{E4} is present between an end of the fourth electrode layer E4 and the side surface 3a. The third electrode layer E3 has a gap between the second ridge portion and the third electrode layer E3, and the fourth electrode layer E4 has a gap between the second ridge portion and the fourth electrode layer E4. Widths of the gaps G_{E3} and G_{E4} are, for example, larger than 0 and equal to or less than 3 μm. Widths of the gaps between the second ridge portion and the third electrode layer E3 and between the second ridge portion and the fourth electrode layer E4, for example, larger than 0 and equal to or less than 3 μm. The widths of the gap G_{E3} and the gap G_{E4} may be different from each other. The widths of the gaps G_{E3} and G_{E4} may be different from the widths of the gaps between the third electrode layer E3 and the second ridge portion and between the fourth electrode layer E4 and the second ridge portion.

As illustrated in FIG. 6, when viewed from a direction perpendicular to the side surface 3a, the second electrode layer E2 extends along an edge 6 of the external electrode 5, on the side surface 3a. The second electrode layer E2 includes an edge E2e that extends along the edge 6 of the external electrode 5. FIG. 6 is a plan view illustrating a second electrode layer.

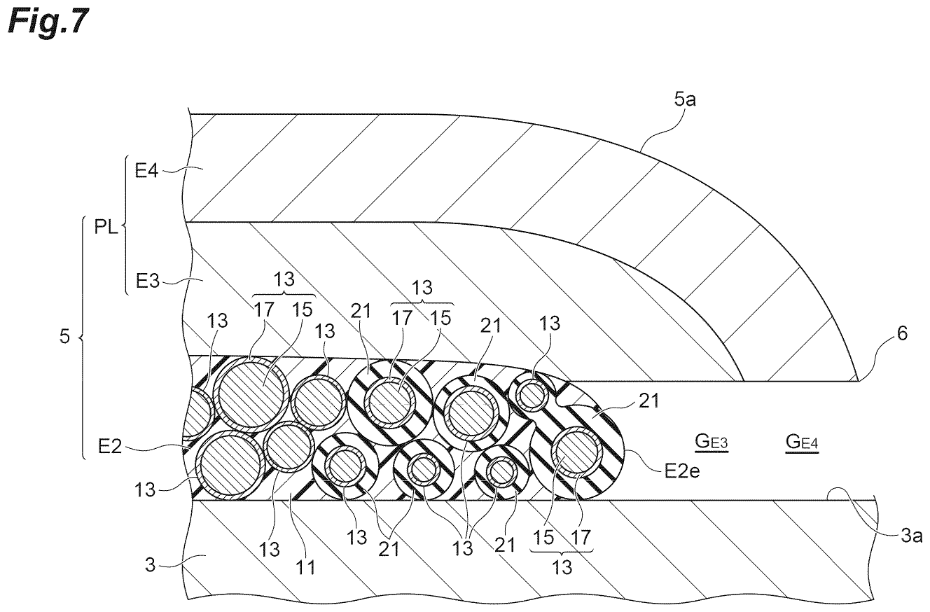

As illustrated in FIGS. 6 and 7, the multilayer capacitor C1 includes an oxide 21. The edge E2e included in the second electrode layer E2 includes the oxide 21. The oxide 21 is positioned on an end side of the second electrode layer E2. The multilayer capacitor C1 includes the oxide 21 in the second electrode layer E2. The oxide 21 extends along the edge 6 of the external electrode 5. For example, the oxide 21 extends continuously along the edge 6 of the external electrode 5. The oxide 21 may extend intermittently along the edge 6 of the external electrode 5. A thickness of the oxide 21 is, for example, 100 to 700 nm. FIG. 7 is a view illustrating a configuration of an external electrode and an oxide. FIG. 7 schematically illustrated a cross-sectional configuration of the external electrode 5. The shape and size of the conductive particles 13 illustrated in FIG. 7 may be different from the shape and size of actual conductive particles.

A surface of the edge E2e includes the oxide 21. The edge E2e includes a surface where the oxide 21 is exposed. The entire surface of the edge E2e may include the oxide 21. In a configuration in which the entire surface of the edge E2e includes the oxide 21, the edge E2e includes only the surface where the oxide 21 is exposed. Only a portion of the surface of edge E2e may include the oxide 21. In a configuration in which only a portion of the surface of the edge E2e includes the oxide 21, the remaining portion of the surface of the edge E2e may include the resin or the film 17. In a configuration in which only a portion of the surface of the edge E2e includes the oxide 21, for example, the edge E2e includes a surface where the oxide 21 is exposed and a surface where the resin or film 17 is exposed.

As illustrated in FIG. 7, the oxide 21 is disposed outside the conductive particle 13. The oxide 21 is positioned on a surface of the film 17. The oxide 21 is in contact with the film 17. The oxide 21 may be in contact with the element body 3. The oxide 21 may be in contact with the side surface 3a. The oxide 21 may be in contact with the second ridge portion. The oxide 21 may be in contact with the plating layer PL. For example, as illustrated in FIG. 7, the oxide 21 may be integrally formed outside a plurality of conductive particles 13 adjacent to each other.

The oxide 21 includes, for example, an oxide of a metal component included in the conductive particle 13. The oxide 21 includes, for example, an oxide including silver and copper. The oxide including the silver and the copper is represented by, for example, (Agₓ, Cu₁₋ₓ)O_{y}. The oxide 21 may include an oxide of copper. The oxide 21 includes, for example, an electrical insulator.

The oxide 21 is formed, for example, through heat-treating the second electrode layer E2. Heat-treating the second electrode layer E2 may be performed, for example, after the third electrode layer E3 is formed and before the fourth electrode layer E4 is formed. Heat-treating the second electrode layer E2 may be performed after the fourth electrode layer E4 is formed. The conditions for heat-treating the second electrode layer E2 include, for example, a heating temperature or a heating period.

Oxygen bonded to the metal component included in the conductive particle 13 tends to reach the edge E2e of the second electrode layer E2 through the gaps G_{E3} and G_{E4}. The oxygen tends to enter through the gaps G_{E3} and G_{E4}. When heat-treating the second electrode layer E2, heat tends to act on the edge E2e of the second electrode layer E2 through the gaps G_{E3} and G_{E4}. Therefore, the oxide 21 tends to be produced in the conductive particle 13 closer to the edge E2e of the second electrode layer E2 more than in the conductive particle 13 far from the edge E2e of the second electrode layer E2.

When heat-treating the second electrode layer E2 is performed after the third electrode layer E3 is formed and before the fourth electrode layer E4 is formed, an oxide of the metal included in the third electrode layer E3, for example, an oxide of nickel may be produced on the surface at the end of the third electrode layer E3. The oxide of nickel tends to form a passive film and not to grow. Therefore, the third electrode layer E3 tends to have a gap between the third electrode layer E3 and the element body 3.

When heat-treating the second electrode layer E2 is performed after the fourth electrode layer E4 is formed, an oxide of the metal included in the fourth electrode layer E4, for example, an oxide of tin may be produced on the surface at the end of the fourth electrode layer E4. The oxide of tin tends to form a passive film and not to grow. Therefore, the fourth electrode layer E4 tends to have a gap between the fourth electrode layer E4 and the element body 3.

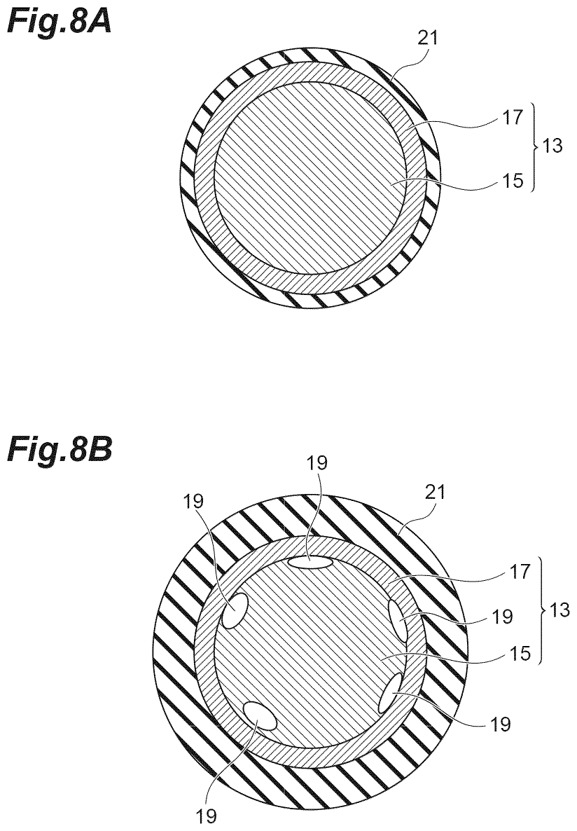

As illustrated in FIGS. 8A and 8B, in heat-treating the second electrode layer E2, for example, the following processes proceed. FIGS. 8A and 8B are views illustrating a configuration of a conductive particle and an oxide. In FIGS. 8A and 8B, the conductive particle 13 and the oxide 21 are schematically illustrated.

The copper that has migrated to a surface side of the conductive particle 13 binds to oxygen together with the silver included in the film 17. Consequently, as illustrated in FIG. 8A, the oxide 21 including the copper and the silver is produced on the surface of the conductive particle 13, that is, on the surface of the film 17. The oxide 21 includes the oxide including the copper and the silver included in the conductive particle 13. The copper is derived from the copper included in the core 15. The silver is derived from the silver included in the film 17. The oxide 21 is formed, for example, in a film shape. The mechanism by which the copper included in the core 15 migrates toward the surface of the conductive particle 13 is not clear. However, it is speculated that in an environment where oxygen is present outside the conductive particles 13, copper, which tends to bond with oxygen more than silver, tends to migrate toward the surface of the conductive particle 13 during heat-treating.

Copper migration progresses, and the oxide 21 grows. Copper tends to expand in volume due to oxidation. Consequently, a thickness of the oxide 21 increases as illustrated in FIG. 8B. As the copper migrates, a void 19 is formed in the conductive particle 13. The void 19 tends to be formed near the surface of the core 15. The vicinity of the surface of the core 15 includes an interface between the core 15 and the film 17.

The plurality of conductive particles 13 include a plurality of conductive particles 13 in which the oxide 21 is produced and a plurality of conductive particles 13 in which oxide 21 is not produced. The plurality of conductive particles 13 in which oxide 21 is not produced tend to contribute to the electrical conductivity of the second electrode layer E2. For example, as illustrated in FIG. 7, the plurality of conductive particles 13 in which the oxides 21 are produced tend to be positioned at the edge E2e of the second electrode layer E2 or in the vicinity of the edge E2e. The second electrode layer E2 of the electrode portion 5e tends to include the conductive particles 13 in which the oxide 21 is not produced. The second electrode layer E2 of the electrode portion 5a tends to include the conductive particles 13 in which the oxide 21 is formed.

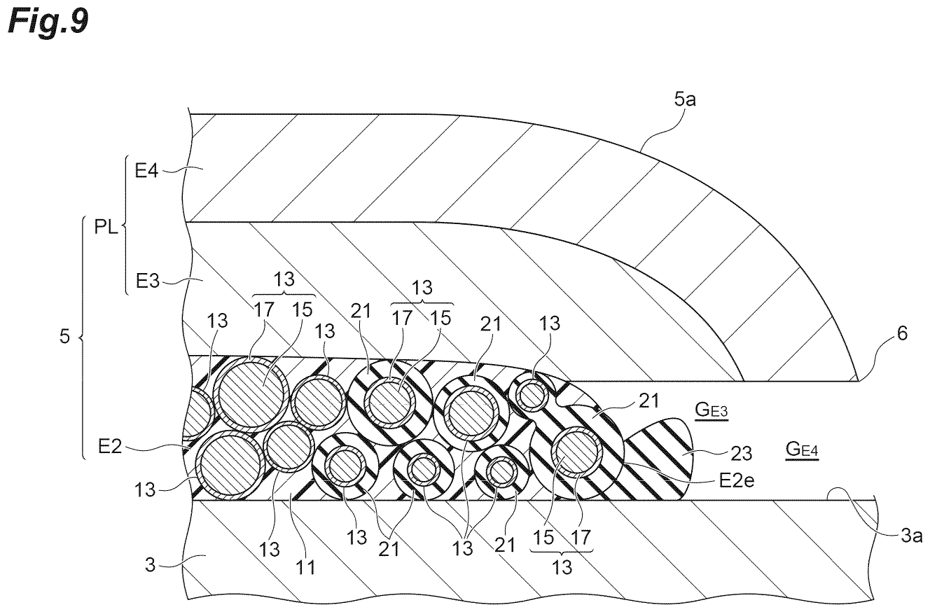

As illustrated in FIG. 9, the multilayer capacitor C1 may include an oxide 23. The oxide 23 is disposed, for example, at the edge E2e included in the second electrode layer E2. The second electrode layer E2 includes the edge E2e where the oxide 23 is disposed. The oxide 23 is positioned on the end side of the second electrode layer E2. FIG. 9 is a view illustrating a configuration of an external electrode and an oxide. FIG. 9 schematically illustrated a cross-sectional configuration of the external electrode 5. The shape and size of the conductive particles 13 illustrated in FIG. 9 may be different from the shape and size of actual conductive particles.

The oxide 23 is positioned in the gap G_{E3}. The oxide 23 may be in contact with the element body 3. The oxide 23 may be in contact with the side surface 3a. The oxide 23 may be in contact with the second ridge portion. The oxide 23 may be in contact with the third electrode layer E3. The oxide 23 may be positioned not only in the gap G_{E3} but also in the gaps G_{E3} and G_{E4}. A thickness of the oxide 23 is, for example, larger than 0 and equal to or less than 3 μm. A width of the oxide 23 is, for example, larger than 0 and equal to or less than 30 μm.

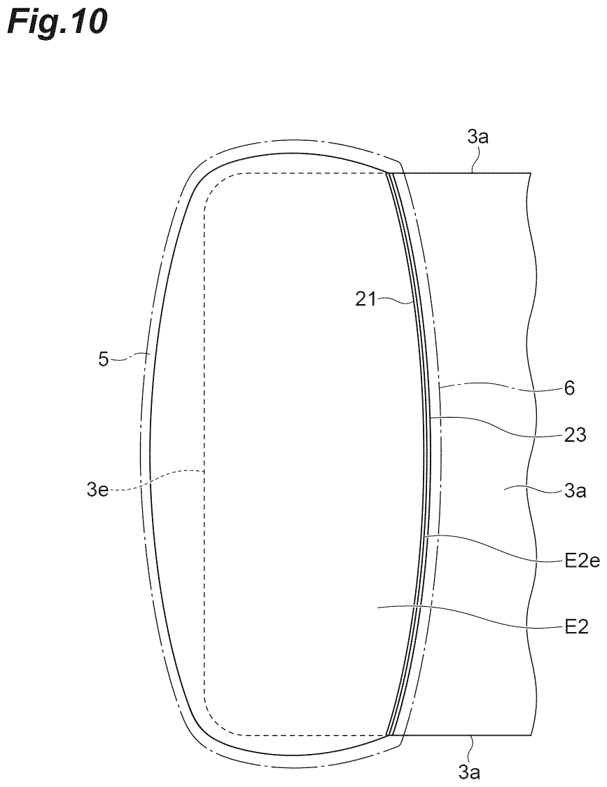

As illustrated in FIG. 10, the oxide 23 extends along the edge 6 of the external electrode 5, similarly to the oxide 21. For example, the oxide 23 extends continuously along the edge 6 of the external electrode 5. The oxide 23 may extend intermittently along the edge 6 of the external electrode 5. FIG. 10 is a plan view illustrating a second electrode layer.

The oxide 23 includes, for example, an oxide of a metal component included in the conductive particle 13, same as the oxide 21. The oxide 23 includes, for example, an oxide including silver and copper. The oxide including the silver and the copper is represented by, for example, (Agₓ, Cu₁₋ₓ)O_{y}. The oxide 23 may include an oxide of copper. The oxide 23 includes, for example, an electrical insulator.

The oxide 23 is formed, for example, through heat-treating the second electrode layer E2, in the same way as the oxide 21. The mechanism by which the oxide 23 is produced is not clear. However, it is speculated that the oxide 23 is produced at the edge E2e as the production of the oxide 21 further progresses. The oxide 23 may be produced integrally with the oxide 21.

In the multilayer capacitor C1, the oxide 21 is positioned on the end side of the second electrode layer E2. The oxide 21 tends not to cause migration more than silver. The oxide 21 prevents a silver ion from migrating from the second electrode layer E2. Therefore, even in an environment in which silver migration may occur, the silver migration tends not to progress from the second electrode layer E2. The multilayer capacitor C1 prevents progress of silver migration.

In the multilayer capacitor C1, the oxide 23 is positioned on the end side of the second electrode layer E2. The oxide 23 tends not to cause migration more than silver. The oxide 23 prevents a silver ion from migrating from the second electrode layer E2. Therefore, even in an environment in which silver migration may occur, the silver migration tends not to further progress from the second electrode layer E2. The multilayer capacitor C1 further prevents progress of silver migration.

In the multilayer capacitor C1, for example, the second electrode layer E2 may include the edge E2e including the oxide 21.

In a configuration in which the second electrode layer E2 includes the edge E2e including the oxide 21, the second electrode layer E2 includes the oxide 21 at the edge E2e. Therefore, this configuration reliably prevents the progress of silver migration.

In the multilayer capacitor C1, for example, the edge E2e may include the surface where the oxide 21 is exposed.

A configuration in which the edge E2e includes the surface where the oxide 21 is exposed further reliably prevents the progress of silver migration.

In the multilayer capacitor C1, for example, the external electrode 5 may include the plating layer PL disposed outside the second electrode layer E2 with the gap between the plating layer PL and the element body 3. For example, the third electrode layer E3 may have the gap G_{E3} between the third electrode layer E3 and the element body 3, and the fourth electrode layer E4 may have the gap G_{E4} between the fourth electrode layer E4 and the element body 3. For example, the oxide 21 may be exposed to the gap between the plating layer PL and the element body 3.

In a configuration in which the external electrode 5 includes the plating layer PL, the plating layer PL has the gap between the plating layer PL and the element body 3. For example, oxygen tends to enter through the gap between the plating layer PL and the element body 3 when heat-treating the second electrode layer E2. Therefore, even in a configuration in which the external electrode 5 includes the plating layer PL, the oxide 21 can be reliably disposed.

In a configuration in which the oxide 21 is exposed to the gap between the plating layer PL and the element body 3, the oxide 21 prevents silver ion from migrating from the second electrode layer E2 to the gap between the plating layer PL and the element body 3. Therefore, even in a configuration in which the plating layer PL has the gap between the plating layer PL and the element body 3, a configuration in which the oxide 21 is exposed to the gap between the plating layer PL and the element body 3 reliably prevents the progress of silver migration.

In the multilayer capacitor C1, for example, the second electrode layer E2 may include the edge E2e on which the oxide 23 is disposed.

In a configuration in which the second electrode layer E2 includes the edge E2e on which the oxide 23 is disposed, the oxide 23 is positioned in front of the edge E2e of the second electrode layer E2. Therefore, this configuration reliably prevents the progress of silver migration.

In the multilayer capacitor C1, for example, the external electrode 5 may include the plating layer PL, and the oxide 23 may be positioned in the gap between the plating layer PL and the element body 3.

In a configuration in which the external electrode 5 includes the plating layer PL, the oxide 23 can be easily and reliably disposed as described above.

In a configuration in which the oxide 23 is positioned in the gap between the plating layer PL and the element body 3, the oxide 23 prevents silver ion from migrating through the gap between the plating layer PL and the element body 3. Therefore, even in a configuration in which the plating layer PL has the gap between the plating layer PL and the element body 3, a configuration in which the oxide 23 is positioned in the gap between the plating layer PL and the element body 3 reliably prevents the progress of silver migration.

In the multilayer capacitor C1, for example, the oxide 21 may include the oxide of the metal component included in the conductive particle 13.

In a configuration in which the oxide 21 includes the oxide of the metal component included in the conductive particle 13, the oxide included in the edge E2e of the second electrode layer E2 includes the oxide of the metal component included in the conductive particle 13. Therefore, this configuration reliably and easily provides the oxide 21 positioned on the end side of the second electrode layer E2. This configuration reliably and easily provides the oxide 23 positioned on the end side of the second electrode layer E2.

In the multilayer capacitor C1, for example, the conductive particle 13 may include copper, and the oxide may include an oxide of the silver and the copper.

In a configuration in which the oxide 21 includes the oxide including the silver and the copper, for example, the oxide 21 may be formed through heat-treating the second electrode layer E2. Therefore, this configuration can more easily provide the oxide 21 positioned on the end side of the second electrode layer E2. This configuration can more easily provide the oxide 23 positioned on the end side of the second electrode layer E2.

In the multilayer capacitor C1, for example, the conductive particle 13 may include the core 15 including the copper, and the film 17 including the silver and covering the core 17.

A configuration in which the conductive particle 13 includes the core 15 including the copper and the film 17 including the silver reduces electrical resistance of the conductive particle 13 as compared with a configuration in which the conductive particle 13 includes only copper. Therefore, this configuration in which the conductive particle 13 includes the core 15 including the copper and the film 17 including the silver reduces the electrical resistance of the second electrode layer E2 and reduces the ESR of the multilayer capacitor C1. This configuration can reliably and easily form the oxide 21 including the silver and the copper. This configuration can reliably and easily form the oxide 23 including the silver and the copper.

In the multilayer capacitor C1, for example, the oxide 21 may be positioned on the surface of the film 17.

A configuration in which the oxide 21 is positioned on the surface of the film 17 can further reliably provide the oxide 21 positioned on the end side of the second electrode layer E2. This configuration can further reliably provide the oxide 23 positioned on the end side of the second electrode layer E2.

In the multilayer capacitor C1, for example, the oxide 21 may extend along the edge 6 of the external electrode 5.

A configuration in which the oxide 21 extends along the edge 6 of the external electrode 5 reliably prevents the progress of silver migration.

In the multilayer capacitor C1, for example, the oxide 23 may extend along the edge 6 of the external electrode 5.

A configuration in which the oxide 23 extends along the edge 6 of the external electrode 5 reliably prevents the progress of silver migration.

In the present specification, in a case where an element is described as being disposed on another element, the element may be directly disposed on the other element or be indirectly disposed on the other element. In a case where an element is indirectly disposed on another element, an intervening element is present between the element and the other element. In a case where an element is directly disposed on another element, no intervening element is present between the element and the other element.

In the present specification, in a case where an element is described as being positioned on another element, the element may be directly positioned on the other element or be indirectly positioned on the other element. In a case where an element is indirectly positioned on another element, an intervening element is present between the element and the other element. In a case where an element is directly positioned on another element, no intervening element is present between the element and the other element.

In the present specification, in a case where an element is described as covering another element, the element may directly cover the other element or indirectly cover the other element. In a case where an element indirectly covers another element, an intervening element is present between the element and the other element. In a case where an element directly covers another element, no intervening element is present between the element and the other element.

It is to be understood that not all aspects, advantages and features described herein may necessarily be achieved by, or included in, any one particular example. Indeed, having described and illustrated various examples herein, it should be apparent that other examples may be modified in arrangement and detail.

The multilayer capacitor C1 including the oxide 23 may not include the oxide 21. In the multilayer capacitor C1 including the oxide 23, the second electrode layer E2 may not include the edge E2e including the oxide 21. A process of providing the oxide 23 on the edge E2e of the second electrode layer E2 that does not include the oxide 21 may include applying an oxide along the edge E2e of the second electrode layer E2 before forming the plating layer PL without performing the above-mentioned heat-treating after forming the second electrode layer E2. In this case, the above-mentioned heat-treating after forming the second electrode layer E2 is not performed.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body; and
an external electrode disposed on the element body, the external electrode including a conductive resin layer including a plurality of conductive particles, wherein
the plurality of conductive particles include a metal component including silver, and
an oxide is positioned on an end side of the conductive resin layer.

2. The electronic component according to claim 1, wherein
the conductive resin layer includes an edge including the oxide.

3. The electronic component according to claim 2, wherein
the edge includes a surface where the oxide is exposed.

4. The electronic component according to claim 2, wherein
the external electrode includes a plating layer disposed outside the conductive resin layer with a gap between the plating layer and the element body, and
the oxide is exposed to the gap.

5. The electronic component according to claim 1, wherein
the conductive resin layer includes an edge on which the oxide is disposed.

6. The electronic component according to claim 5, wherein
the external electrode includes a plating layer disposed outside the conductive resin layer with a gap between the plating layer and the element body, and
the oxide is positioned in the gap.

7. The electronic component according to claim 1, wherein
the oxide includes an oxide of the metal component included in the conductive particle.

8. The electronic component according to claim 7, wherein
the conductive particle further includes copper, and
the oxide includes an oxide of the silver and the copper.

9. The electronic component according to claim 8, wherein
the conductive particle includes a core including the copper, and a film including the silver and covering the core.

10. The electronic component according to claim 9, wherein
the oxide is positioned on a surface of the film.

11. The electronic component according to claim 1, wherein
the oxide extends along an edge of the external electrode.
